(19) United States
(12) Patent Application Publication
(10) Pub. No.: US 2020/0317334 A1
(43) Pub. Date: Oct. 8, 2020

(54) UNMANNED AERIAL VEHICLES AND FLIGHT PLANNING METHODS AND APPARATUS

(71) Applicant: Intel Corporation, Santa Clara, CA (US)

(72) Inventors: Kirk W. Skeba, Fremont, CA (US); David W. Browning, Beaverton, OR (US); Muhammad Abozaed, Haifa (IL); Anuradha Srinivasan, Bangalore (IN)

(21) Appl. No.: 16/465,985

(22) PCT Filed: Aug. 28, 2017
(86) PCT No.: PCT/US17/48950

§ 371 Date: Dec. 19, 2019

(30) Foreign Application Priority Data
Dec. 15, 2016 (IN) 201641042730

(51) Int. Cl. B64C 39/02; G05D 1/00

(52) U.S. Cl. CPC B64C 39/024; B64C 2201/127; B64C 2201/141; G05D 1/0022

(57) ABSTRACT

Unmanned aerial vehicles and flight planning methods and apparatus are disclosed. An example apparatus includes an unmanned vehicle including a body and a propulsion source to propel the unmanned vehicle during flight; and a route planner to determine a route through an area including a restriction, the route planner to negotiate access through the restricted area.

### FIELD OF THE DISCLOSURE

This disclosure relates generally to unmanned aerial vehicles, and, more particularly, to unmanned aerial vehicles and flight planning methods and apparatus.

### BACKGROUND

When planning a flight, no-fly zones may be taken into account. In some examples, no-fly zones prevent the aircraft from flying therethrough. If the aircraft cannot fly through the no-fly zone, the flight time or distance traveled may be greater than if the aircraft were permitted to fly through the no-fly zone.

### BRIEF DESCRIPTION OF THE DRAWINGS

FIG. 1 is a schematic illustration of an example environment of use where an example unmanned aerial vehicle including an example route planner can be used.

FIG. 2 is a block diagram of an example implementation of the example route planner of FIG. 1.

FIG. 3 is a block diagram of an example implementation of an example area controller that can be used to implement the first area controller, the second area controller and/or the third area controller of FIG. 1.

FIG. 4 is a flowchart representative of machine readable instructions that may be executed to implement the route planner of FIGS. 1 and 2.

FIG. 5 is a flow chart representative of machine readable instructions that may be executed to implement the route planner of FIGS. 1 and 2 and to perform the processes of FIG. 4 to negotiate access through a restricted area(s) along a flight path associated with a mission objective.

FIG. 6 is a flow chart representative of machine readable instructions that may be executed to implement the route planner of FIGS. 1 and 2 and to perform the processes of FIG. 4 to dynamically adjust the configuration of the UAV based on the first and second positional data to enable compliancy with a restriction.

FIG. 7 is a flowchart representative of machine readable instructions that may be executed to implement the respective area controllers of FIGS. 1 and 2.

FIG. 8 is a processor platform to execute the instructions of FIGS. 4, 5 and 6 to implement the route planner of FIGS. 1 and/or 2.

FIG. 9 is a processor platform to execute the instructions of FIG. 7 to implement the respective area controllers of FIGS. 1 and/or 3.

The figures are not to scale. Wherever possible, the same reference numbers will be used throughout the drawing(s) and accompanying written description to refer to the same or like parts.

### DETAILED DESCRIPTION

In some examples, a person or other entity associated with an area (e.g., a geo-fenced area) may implement a restriction(s) that affects a flight path of an unmanned aerial vehicle (UAV) and/or unmanned vehicle (UV) through the area. The restriction(s) may be associated with the capabilities of the UAV when flying through the area, the payload the UAV may carry when flying through the area and/or the time the UAV may fly through the area. Additionally and/or alternatively, the restriction(s) may be associated with the weight the UAV may be when flying through the area, the speed that the UAV may fly when flying through the area, the noise the UAV may generate when flying through the area, the pitch that the propellers of the UAV may have when flying through the area and/or the number of motors that the UAV may operate when flying through the area.

To enable UAVs a more direct flight path and/or route through these restricted areas, the examples disclosed herein enable UAVs to negotiate access through these restricted areas based on the UAV complying with the restriction(s) and/or paying an access fee or toll. In other words, the examples disclosed herein enable UAVs that comply with an imposed restriction and/or fulfill some other requirement (e.g., pay a toll) access through an otherwise restricted area. Thus, the examples disclosed herein enable faster flight times, more efficient flights and, more generally, save cost by reducing flight times and/or fuel/energy consumption. The negotiation may take place prior to take off, in real-time and/or dynamically during the course of the flight. Regardless of when the negotiation takes place, in some examples, the UAVs include a control(s), a set of controls and/or an attribute profile(s) that publicly discloses compliancy and/or the configuration(s) of the UAV. Such an approach of communicating compliance of a UAV flying over an area (e.g., a semi-restricted area, a private area, a restricted area, etc.) may reduce some privacy concerns associated with UAVs such as, for example, privacy concerns associated with image data and/or video data being obtained of private events.

In some examples, after determining that a possible flight path travels through a restricted area and negotiating access through the restricted area, the UAV provides a notice that certifies compliance with the restriction. The notice may be provided to the restricted area and/or a controller associated with the restricted area. In some examples, the notice may be provided prior to flight and/or during flight.

In some examples, the notice certifying compliance may include an identification of the UAV, a description of the UAV (e.g., a delivery UAV, a surveillance UAV), the number of motors (e.g. four controllable motors) being operated by the UAV and/or the noise (e.g., 90 decibels (dB)) being emitted by the UAV. Additionally and/or alternatively, in some examples, the notice certifying compliance may include the presence and/or status of a camera on the UAV, the video storage capabilities of the UAV and/or the global positioning system (GPS) capabilities of the UAV. Additionally and/or alternatively, in some examples, the notice certifying compliance may include the presence and/or capabilities of an inertial measurement unit (IMU) on the UAV, the maximum speed of the UAV, the minimum speed of the UAV, the weight of the payload carried by the UAV, the presence of hazardous material(s) within the payload carried by the UAV and/or the content(s) of the payload carried by the UAV. In other words, the notice certifying compliance and/or the configuration of the UAV may include different parameters and/or data associated with the UAV, the mission of the UAV, etc.

Because the restrictions imposed by some areas may adversely affect and/or compromise other objectives of a mission, the examples disclosed herein enable configurations and/or settings of UAVs to be dynamically adjusted during flight. For example, if a first area imposes a no-camera restriction and the objective of the mission is to obtain image data of a second area, the UAV may dynamically disable and/or turn the camera off when flying through the first area and enable and/or turn the camera on when flying over the second area. Thus, the UAV is able to comply with the no-camera restriction imposed by the first area and enable the mission objective of obtaining image data of the second area to be achieved. While this example mentions enabling and disabling a camera, other examples exist of dynamically controlling a UAV subsystem(s) to enable compliance with different restrictions imposed by different areas. For example, the speed, the noise output, the blade pitch and/or the number of motors being operated may be changed to enable a UAV to comply with a particular restriction(s) using hardware, a control system and/or a power mechanism(s) onboard the UAV.

To enable the UAV to comply with different restrictions imposed by an area, the UAV may communicate with a ground-based system, an air-based system and/or a space-based system prior to and/or during a mission and/or flight. The communication between the UAV and the respective system(s) may be accomplished in any suitable way. For example, communication between the UAV and the ground-based system may take place over a peer-to-peer (P2P) mesh network(s) and/or a primary communication network(s). In examples in which a P2P is used, the UAV may communicate with a transmitter(s) on the ground to enable real-time flight planning and/or negotiation between the UAV and the area implementing a restriction. In examples in which a primary communication network(s) (e.g., third generation (3G), long-term evolution (LTE)) is used, the UAV may report (e.g., periodically report) its position to the primary communication network to enable real-time flight planning and/or negotiation between the UAV and the area implementing a restriction. In either of these examples, satellite dishes, communication towers, satellites, etc., may be used to convey information (e.g., normal communication, emergency communication) to and from the UAV. In some examples, fees may be charged for using these P2P networks and/or associated infrastructures.

While in some examples the UAV and/or the associated mission may be in compliance with a restriction imposed on an area, other examples exist where the UAV and/or the mission does not comply with the restriction and/or other circumstances arise that prevent compliance with the restriction (e.g., range/energy/battery life and/or system health of the UAV). For example, if the mission objective requires that the flight occur at 7:00 pm and an area implements a no-fly restriction after 6:00 pm, the UAV would be unable to fly through the area without breaking the 6:00 pm curfew unless a compromise is reached. In some examples, to enable the mission objectives to be achieved while also being granted access after the 6:00 pm curfew, the negotiation may include paying a toll and/or access fee to fly through the area after the 6:00 pm no-fly restriction. Such a negotiation may occur prior to flight, during the mission and/or flight and/or in real-time.

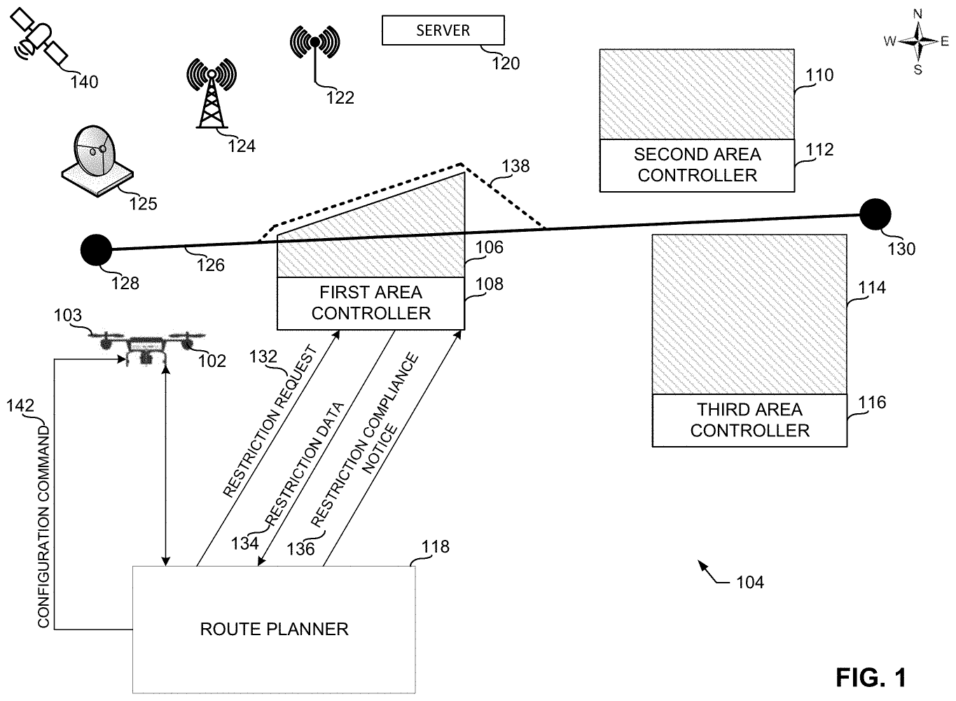

FIG. 1 illustrates an example unmanned aerial vehicle (UAV) 102 having a propulsion source, engines and/or propellers 103 navigating through an example environment 104. As shown in the example of FIG. 1, the environment 104 includes a first restricted area 106 associated with a first area controller 108, a second restricted area 110 associated with a second area controller 112 and a third restricted area 114 associated with a third area controller 116. The restricted areas 106, 110 and 114 may be generated through geo-fencing software and may be associated with an individual building, a group of buildings (e.g., a block) and/or any other geographic area. In this example, the UAV 102 includes and/or is associated with an example route planner 118 that communicates with the first, second and/or third area controllers 108, 112, 116. In some examples, the UAV 102 and/or the first, second and/or third area controllers 108, 112, 116 communicate over an example server 120 via an example wireless access point 122, an example cellular base station 124 and/or an example satellite dish 125. While some methods of enabling communication between the route planner 118 and the first, second and/or third area controllers 108, 112 and 116 are shown in FIG. 1, communication may occur in any other way.

In some examples, the UAV 102 is tasked to perform a mission having mission objectives. The mission objectives may define the task to be performed (e.g., deliver a package) and/or the time or schedule that the task is to be performed. In the illustrated example, based on the mission objective, the route planner 118 determines a first route and/or flight path 126 between a first location 128 and a second location 130. The first route 126 may be the fastest route and/or the shortest route between the first location 128 and the second location 130. However, while the first route 126 may be the most efficient route for the UAV 102 to travel between the first location 128 and the second location 130, the first route 126 also passes through the first restricted area 106 that imposes a restriction(s) on travel through the first restricted area 106. For example, the first restricted area 106 may restrict the ability of the UAV 102 from obtaining image data when flying through the first restricted area 106, the ability of the UAV 102 to fly through the first restricted area 106 at certain times unless a toll or access fee is paid and/or the ability of the UAV 102 to generate a threshold amount of noise when flying through the first restricted area 106. While the above examples mention the first restricted area 106 and some restrictions that may be imposed on the first restricted area 106, any restriction may be imposed by any of the first, second and/or third restricted areas 106, 110 and/or 114.

In the illustrated example, to enable the UAV 102 to travel along the first route 126 and through the first restricted area 106, the route planner 118 negotiates with the first area controller 108 to enable the UAV 102 to be granted access through the first restricted area 106. The negotiation may occur prior to flight and/or during flight. In this example, the negotiation includes the route planner 118 communicating and/or conveying a restriction request 132 to the first area controller 108 and the first area controller 108 communicating and/or conveying restriction data 134 to the route planner 118 in response to the restriction request 132 received. In some examples, the restriction request 132 is a request requesting what, if any, restrictions are imposed on the first restricted area 106 and the restriction data 134 includes the boundaries and/or restrictions, if any, present on the first restricted area 106. The restrictions present on the first restricted area 106 may be related to the configuration of the UAV 102, the flight times that the UAV 102 may pass through the first restricted area 106, limitations on the mission objectives and/or any access fee and/or tolls associated with passing through the first restricted area 106.

In some examples, to determine whether the mission objective(s) complies with the restriction data 134, in response to the restriction data 134 received, the route planner 118 compares the restriction data 134 to the mission objectives. For example, if the mission objective is to fly through the first restricted area 106 at 1 PM and the first restricted area 106 has a 6 PM curfew, the route planner 118 determines that the mission objective is compliant with the restriction imposed on the first restricted area 106 and communicates and/or otherwise conveys a restriction compliance notice 136 to the first area controller 108. The restriction compliance notice 136 may include data relating to the configuration of the UAV 102 and/or data related to the mission and/or the mission objectives. In other words, the restriction compliance notice 136 may certify that the UAV 102 complies with the restriction(s).

In examples in which the mission objective is to fly through the first restricted area 106 at 7 PM and the first restricted area 106 has a 6 PM curfew, the route planner 118 determines that the mission objective and/or the UAV 102 is not compliant with the restriction imposed by the first restricted area 106. In such examples, the route planner 118 may update the first route 126 to a second route 138 where the second route 138 avoids passing through the first restricted area 106. In other examples, the restriction data 134 may include an option to pay a fee to pass through the first restricted area 106 any time after the 6 PM curfew. While the above examples mention a curfew implemented on the first restricted area 106 as an example type of restriction that may be imposed, the first, second and/or third restricted area(s) 106, 110 and/or 114 may impose any restriction and associate any fee structure therewith.

In examples in which the mission objective is to obtain image data along certain portions of the first route 126 and the first restricted area 106 imposes a no-camera restriction, the ability of the UAV 102 to comply with the no-camera restriction is dependent on the ability of the UAV 102 to disable the camera when flying through the first restricted area 106 and to obtain image data along certain portions of the first route 126. To enable the UAV 102 to comply with the no-camera restriction, in some examples, the UAV 102 is configured to dynamically enable and/or disable different subsystems of the UAV 102 in flight.

To enable the UAV 102 to determine when to enable/disable the different abilities and/or settings of the UAV 102, in some examples, the UAV 102 determines its position by receiving first location and/or positional data from an example GPS satellite 140 and compares the first location data to second location and/or positional data that defines the boundary of the first area 106. The second location data may be accessed and/or included in the restriction data 134. When the UAV 102 approaches the first restricted area 106, in some examples, the route planner 118 communicates and/or conveys a configuration command 142 to the UAV 102 to cause the UAV 102 to disable the camera prior to the UAV 102 entering the first restricted area 106. Upon complying with the no-camera restriction, in some examples, the UAV 102 and/or the route planner 118 provide the restriction compliance notice 136 to the first area controller 108 indicating the same.

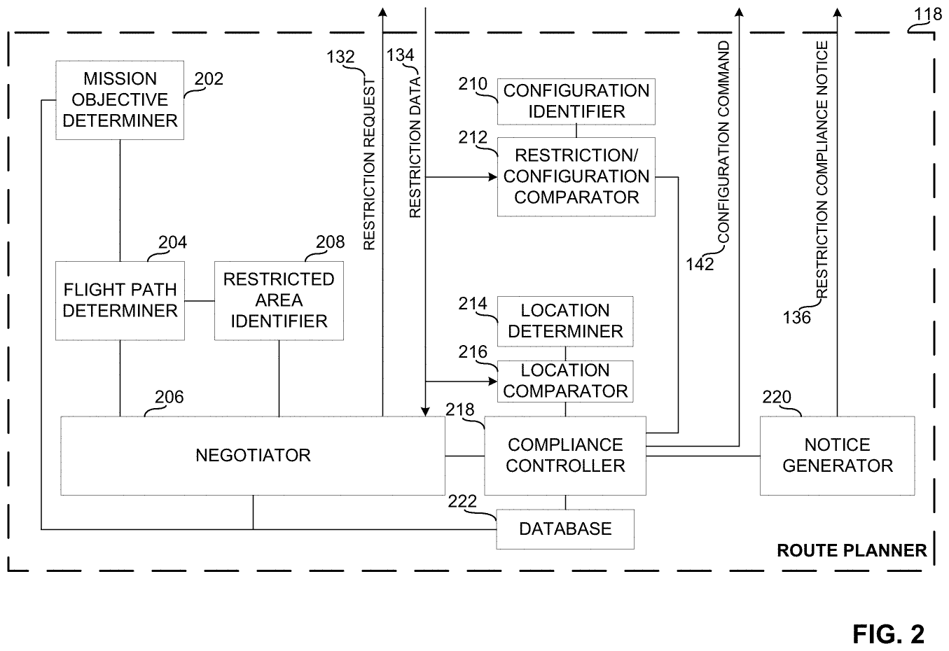

FIG. 2 illustrates an example implementation of the example route planner 118 of FIG. 1. In the illustrated example, the route planner 118 includes an example mission objective determiner 202, an example flight path determiner 204, an example negotiator 206 and an example restricted area identifier 208. Additionally, in the illustrated example, the route planner 118 includes an example configuration identifier 210, an example restriction/configuration comparator 212, an example location determiner 214, an example location comparator 216, an example compliance controller 218, an example notice generator 220 and an example database 222.

In the illustrated example, to determine the mission objective(s) of the UAV 102, the mission objective determiner 202 accesses data and/or mission objective data from the database 222. In some examples, the mission objective(s) includes delivering a package to the second location 130 within a threshold amount of time after leaving the first location 128 and/or delivering the package at the second location 130 at a particular time. Based on the mission objective(s) determined by the mission objective determiner 202, the first route 126 is determined by the flight path determiner 204 and the restricted area identifier 208 identifies the first route 126 as passing through the first restricted area 106.

To negotiate access through the first restricted area 106, in the illustrated example, the negotiator 206 generates the restriction request 132 that is communicated to and/or otherwise conveyed to the first area controller 108. In response to the restriction request 132, in this example, the negotiator 206 accesses and/or otherwise receives the restriction data 134 from the first area controller 108. The restriction data 134 may include the boundaries of the first restricted area 106 and/or any restriction(s) associated with the first restricted area 106.

In response to receiving the restriction data 134, in some examples, the negotiator 206 processes the restriction data 134 to identify a restriction(s) and/or a boundary of the first restricted area 106. To determine if the mission objective(s) is compliant with the restriction(s), in some examples, the negotiator 206 compares the mission objective(s) to the restriction(s). For example, if the restriction imposes an 8 PM flight curfew through the first restricted area 106, the negotiator 206 compares the flight restriction to the proposed flight schedule to verify that the mission objective does not place the UAV 102 in the first restricted area 106 after the 8 PM curfew.

In some examples, if the negotiator 206 determines that the flight schedule does not comply with the restriction(s), the negotiator 206 may further process the restriction data 134 to determine if access is grantable through the first restricted area 106 if a fee or a toll is paid. In such examples, if the negotiator 206 determines that the first area controller 108 will grant access through the first restricted area 106 after the imposed flight curfew if a fee or toll is paid, the negotiator 206 may determine to pay the fee and/or toll. In some examples, the negotiator 206 conveys a fee and/or other payment to the first area controller 108 via the restriction compliance notice 136 and/or any suitable manner. If the negotiator 206 determines not to pay the toll, the negotiator 206 may alternatively cause the flight path determiner 204 to determine the second route 138 that navigates the UAV 102 around the first restricted area 106

In other examples, the restriction(s) imposed on the first restricted area 106 may restrict the use of a subsystem, configuration and/or setting of the UAV 102. In such examples, the negotiator 206 communicates and/or otherwise conveys the restriction to the compliance controller 218 and/or the restriction/configuration comparator 212 to determine whether or not the configuration of the UAV 102 complies with the restriction(s).

To determine whether or not the configuration of the UAV 102 complies with the restriction, in some examples, the configuration identifier 210 determines the configuration of the UAV 102 and the restriction/configuration comparator 212 compares the configuration of the UAV 102 to the restriction(s) imposed on the first restricted area 106 to assess compliance therewith. For example, if the restriction data 134 limits the number of motors being operated to three and the configuration identifier 210 determines that the UAV 102 is operating six motors prior to entering the first restricted area 106, the restriction/configuration comparator 212 will determine that the UAV 102 does not correctly comply with the three-motor limit. To ensure that the UAV 102 complies with the restriction placed on the first restricted area 106 when the UAV 102 flies through the first restricted area 106, the restriction/configuration comparator 212 communicates the discrepancy between the six-motors being used and the three-motor limit to the compliance controller 218.

To determine when the UAV 102 is within a threshold of entering the first restricted area 106, in some examples, the location determiner 214 determines the location of the UAV 102 and the location comparator 216 compares the location of the UAV 102 to the location and/or boundary of the first restricted area 106 to determine the relative positions of the UAV 102 and the restricted area 106. To ensure that the UAV 102 complies with the imposed restriction(s) when the UAV 102 enters and/or flies through the first restricted area 106, in some examples, the compliance controller 218 communicates and/or otherwise provides the configuration command 142 to the UAV 102 to change the status of the subsystem, configuration and/or setting of the UAV 102 when the UAV 102 is within a threshold of the first restricted area 106. In other words, in this example, the configuration command 142 causes the UAV 102 to operate three motors instead of six motors when the UAV 102 is within a threshold of the first restricted area 106. While in this example the configuration command 142 reduces the number of motors being used by the UAV 102, the configuration command 142 may cause the UAV 102 to enable and/or disable any subsystem (e.g., a camera, data transmission capabilities, data storage capabilities, etc.) to enable compliance with a restriction.

To enable the first area controller 108 to be notified of the UAV 102 flying through the first restricted area 106 and/or to enable the first area controller 108 to be notified that the UAV 102 complies with the associated restriction(s) when the UAV 102 enters and/or flies through the first restricted area 106, in the illustrated example, the notice generator 220 communicates and/or otherwise provides the restriction compliance notice 136 to the first area controller 108. In some examples, the restriction compliance notice 136 may include data relating to the configuration of the UAV 102 and/or data relating to the mission of the UAV 102.

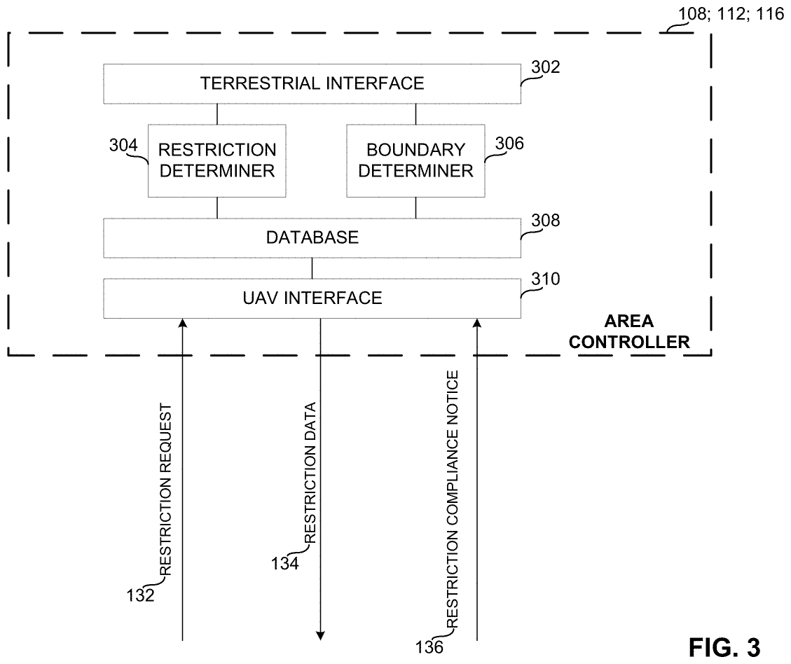

FIG. 3 illustrates an example implementation of the first area controller 108, the second area controller 112 and the third area controller 116. In the illustrated example, the area controller 108, 112, 116 includes an example terrestrial interface 302, an example restriction determiner 304, an example boundary determiner 306, an example database 308 and an example UAV interface 310. While the below example is described with reference to the first area controller 108, the second area controller 112 and/or the third area controller 116 may be implemented in a similar or the same way.

In the illustrated example, the terrestrial interface 302 interfaces with an individual and/or other entity to receive input regarding the first restricted area 106, a restriction(s) associated with the first restricted area 106 and/or a boundary of the first restricted area 106. In some examples, the terrestrial interface 302 receives input to add, remove and/or change a restriction associated with the first restricted area 106. In some examples, the restriction data 134 is stored in the database 308. In some examples, the terrestrial interface 302 receives input to add, remove and/or change a boundary associated with the first restricted area 106. In some examples, the boundary data is stored in the database 308.

To identify a restriction(s), if any, being imposed on the first restricted area 106, in the illustrated example, the restriction determiner 304 accesses the restriction data 134 from the database 308 and identifies the presence of any restrictions associated with the first restricted area 106. To identify the boundary and/or limits of the first restricted area 106, the boundary determiner 306 accesses boundary data from the database 308 and identifies any boundaries associated with the first restricted area 106. In some examples, the boundary data may be included in the restriction data 134.

In the illustrated example, the UAV interface 310 receives and/or accesses the restriction request 132 from the route planner 118. After receiving the restriction request 132, in this example, the UAV interface 310 accesses the restriction data 134 from the database 308 and communicates and/or otherwise conveys the restriction data 134 to the route planner 118. The restriction data 134 may include restrictions when traveling through the first restricted area 106, tolls or fees to be paid when traveling through the first restricted area 106, speed restrictions imposed when traveling through the first restricted area 106, height restrictions (e.g., a minimum height) when traveling through the first restricted area 106, noise restrictions when traveling through the first restricted area 106 and/or UAV subsystem restrictions when traveling through the first restricted area 106. In response to providing the restriction data 134, the UAV interface 310 receives and/or accesses the restriction compliance notice 136 communicated and/or conveyed by the route planner 118.

While an example manner of implementing the route planner 118 of FIG. 1 is illustrated in FIG. 2 and an example manner of implementing the area controller 108, 112, 116 of FIG. 1 is illustrated in FIG. 3, one or more of the elements, processes and/or devices illustrated in FIGS. 2 and/or 3 may be combined, divided, re-arranged, omitted, eliminated and/or implemented in any other way. Further, the example mission objective determiner 202, the example flight path determiner 204, the example negotiator 206, the example restricted area identifier 208, the configuration identifier 210, the example restriction/configuration comparator 212, the example location determiner 214, the example location comparator 216, the example compliance controller 218, the example notice generator 220, the example database 222, the example terrestrial interface 302, the example restriction determiner 304, the example boundary determiner 306, the example database 308 and/or the example UAV interface 310 and/or, more generally, the example route planner 118 of FIG. 1 and the example first area controller 108, the example second area controller 112 and the example third area controller 116 of FIG. 1, may be implemented by hardware, software, firmware and/or any combination of hardware, software and/or firmware. Thus, for example, any of the example the example mission objective determiner 202, the example flight path determiner 204, the example negotiator 206, the example restricted area identifier 208, the configuration identifier 210, the example restriction/configuration comparator 212, the example location determiner 214, the example location comparator 216, the example compliance controller 218, the example notice generator 220, the example database 222, the example terrestrial interface 302, the example restriction determiner 304, the example boundary determiner 306, the example database 308 and/or the example UAV interface 310 and/or, more generally, the example route planner 118 of FIG. 1 and the example first area controller 108, the example second area controller 112 and the example third area controller 116 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example mission objective determiner 202, the example flight path determiner 204, the example negotiator 206, the example restricted area identifier 208, the configuration identifier 210, the example restriction/configuration comparator 212, the example location determiner 214, the example location comparator 216, the example compliance controller 218, the example notice generator 220, the example database 222, the example terrestrial interface 302, the example restriction determiner 304, the example boundary determiner 306, the example database 308 and/or the example UAV interface 310 and/or, more generally, the example route planner 118 of FIG. 1 and the example first area controller 108, the example second area controller 112 and the example third area controller 116 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example the example route planner 118 of FIG. 1 and the example first area controller 108, the example second area controller 112 and the example third area controller 116 of FIG. 1 may include one or more elements, processes and/or devices in addition to, or instead of, those illustrated in FIGS. 2 and/or 3, and/or may include more than one of any or all of the illustrated elements, processes and devices.

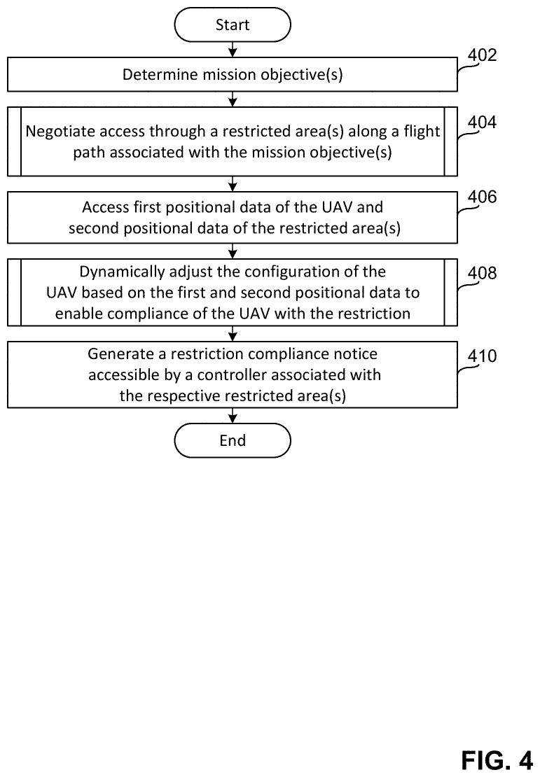

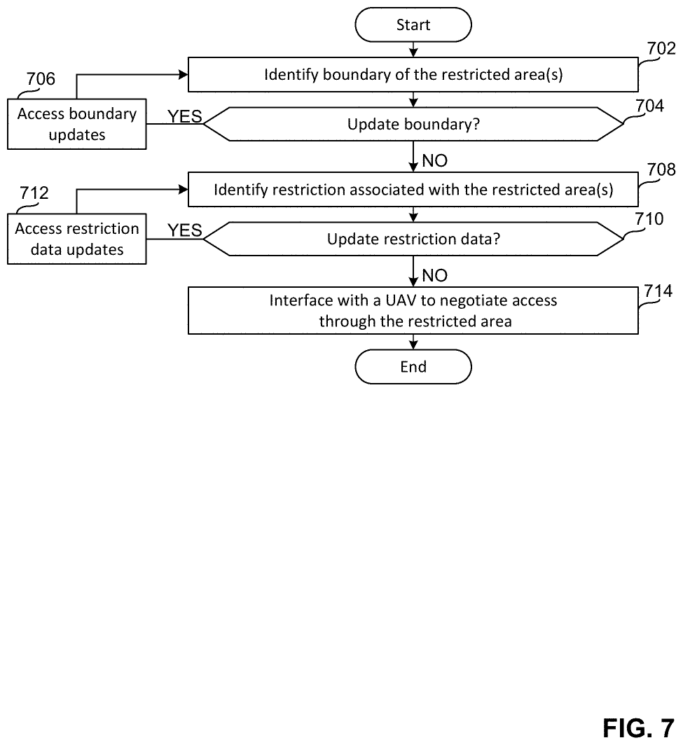

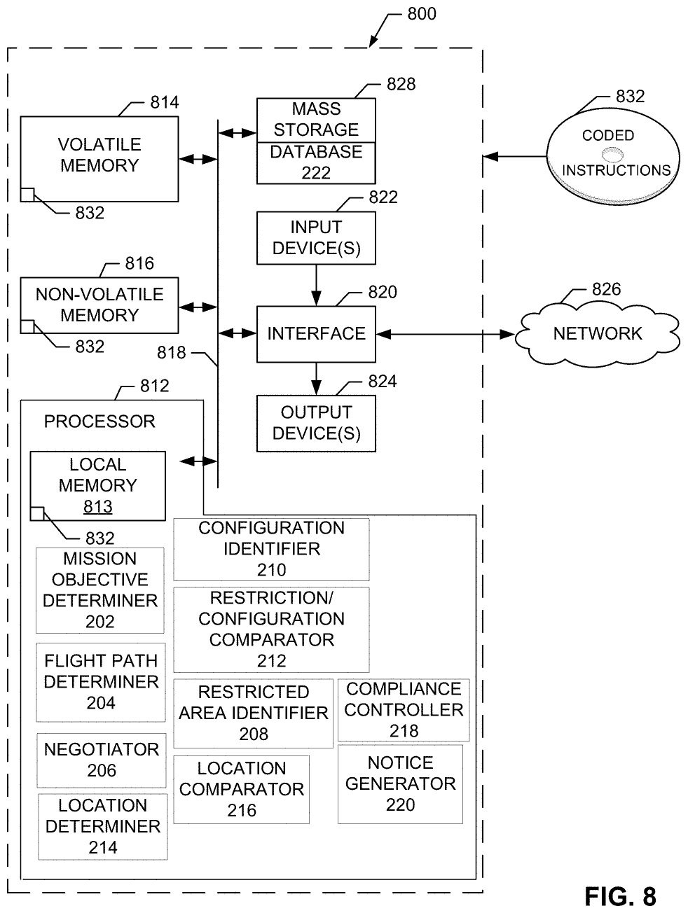

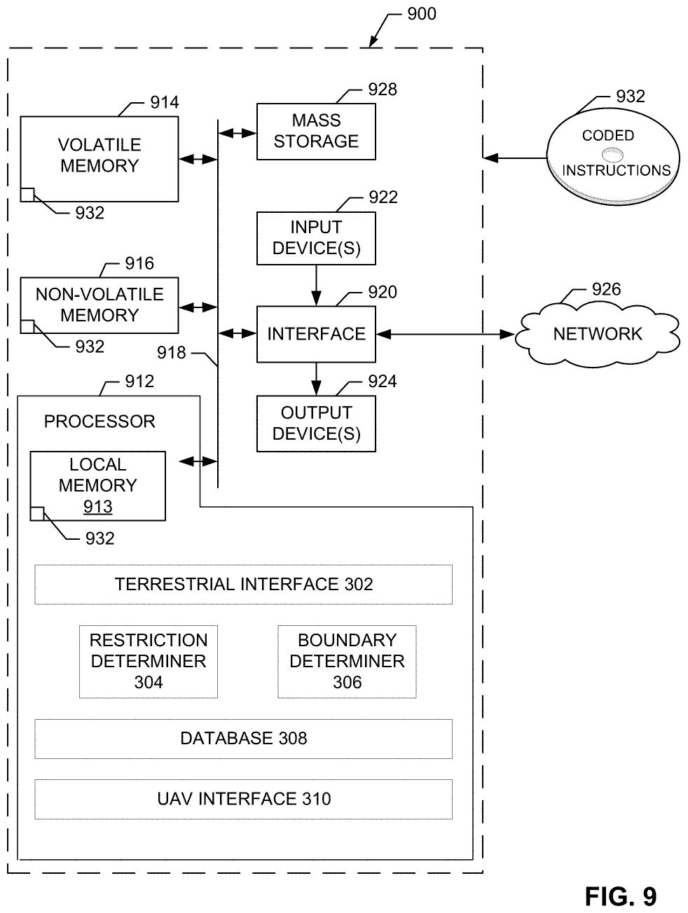

Flowcharts representative of example machine readable instructions for implementing the route planner 118 of FIGS. 1 and 2 are shown in FIGS. 4, 5 and 6 and a flowchart representative of machine readable instructions for implementing the first area controller 108 of FIGS. 1 and 3 is shown in FIG. 7. In this example, the machine readable instructions comprise a program for execution by a processor such as the processors 812, 912 shown in the example processor platform 800, 900 discussed below in connection with FIGS. 8, 9. The program may be embodied in software stored on a tangible computer readable storage medium such as a CD-ROM, a floppy disk, a hard drive, a digital versatile disk (DVD), a Blu-ray disk, or a memory associated with the processors 812, 912, but the entire program and/or parts thereof could alternatively be executed by a device other than the processor 812, 912 and/or embodied in firmware or dedicated hardware. Further, although the example program is described with reference to the flowcharts illustrated in FIGS. 4, 5, 6 and 7, many other methods of implementing the example route planner 118 and the example first area controller 108, the second area controller 112 and the third area controller 116 may alternatively be used. For example, the order of execution of the blocks may be changed, and/or some of the blocks described may be changed, eliminated, or combined.

As mentioned above, the example processes of FIGS. 4, 5, 6 and 7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4, 5, 6 and 7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program of FIG. 4 begins with the mission objective(s) being determined by the mission objective determiner 202 (block 402). Based on the mission objective and a flight path associated with the mission objective passing through a restricted area(s) 106, 110, 114, the negotiator 206 negotiates access through the restricted area(s) 106, 110, 114 (block 404). In some examples, the negotiator 206 negotiates access through the restricted area 106, 110, 114 based on the mission objective(s) complying with the restriction(s) imposed by the restricted area 106, 110, 114, based on the UAV 102 being capable of complying with the restriction(s) imposed by the restricted area 106, 110, 114 and/or based on a fee or other consideration being made.

First positional data of the UAV 102 and second positional data of the restricted area 106, 110, 114 are accessed by the location comparator 216 (block 406). In some examples, the location of the UAV 102 is determined by the location determiner 214. Based on the first and second positional data, the compliance controller 218 generates the configuration command 142 that causes the UAV 102 to dynamically adjust the configuration of the UAV 102 to enable the UAV 102 to comply with the restriction of the restricted area 106, 110, 114 (block 408). The notice generator 220 generates the restriction compliance notice 136 accessible by the area controller 108, 112, 116 associated with the corresponding restricted area(s) 106, 110, 114.

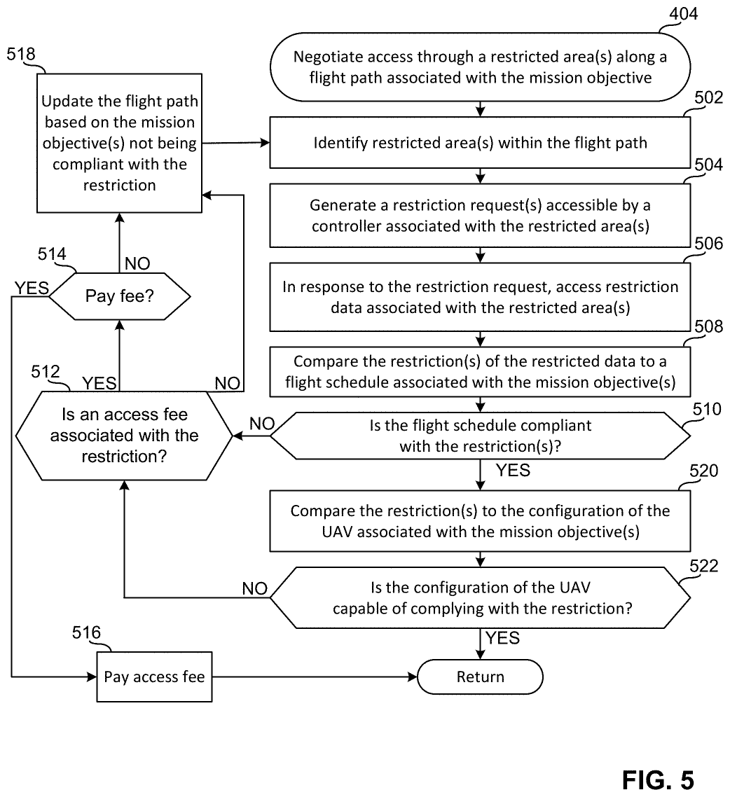

FIG. 5 illustrates an example of performing the processes of block 404 to negotiate access through a restricted area(s) along a flight path associated with the mission objective(s). The program of FIG. 5 begins with the restricted area identifier 208 identifying the restricted area 106, 110, 114 within the flight path 126 (block 502) and the negotiator 206 generating the restriction request 132 that is accessible by the area controller 108, 112, 116 associated with the corresponding restricted area 106, 110, 114 (block 504). In response to the restriction request 132, the negotiator 206 accesses the restriction data 134 associated with the restricted area 106, 110, 114 (block 506). In some examples, the restriction data 134 includes the boundaries of the restricted area 106 and/or any restriction(s) associated with the restricted area 106, 110, 114.

The negotiator 206 compares a restriction(s) included in the restriction data 134 to a flight schedule associated with the mission objective (block 508). In some examples, such a comparison enables the negotiator 206 to determine if the flight schedule is compliant with the restriction(s) (block 510). If the negotiator 206 determines that the flight schedule does not comply with the restriction(s), the negotiator 206 processes the restriction data 134 to determine if an access fee is payable that enables the UAV 102 to pass through the restricted area 106, 110, 114 even though the UAV 102 does not immediately and/or currently comply with the restrictions (block 512).

If an access fee is payable to enable access to be granted through the restricted area 106, 110, 114, the negotiator 206 determines whether or not to pay the fee (block 514). If the negotiator 206 determines to pay the fee, control advances to block 516 and the fee is paid by providing payment and/or other compensation/consideration to the restricted area 106, 110, 114 and/or the associated area controller 108, 112, 116 (block 516). However, if the negotiator 206 determines not to pay the fee, control advances to block 518 and the negotiator 206 causes the flight path determiner 204 to update the flight path to, for example, the second route 138 to enable the UAV 102 to navigate around the restricted area 106, 110, 114 (block 518).

If the negotiator 206 determines that the flight schedule does comply with the restriction(s), control advances to block 520 and the restriction/configuration comparator 212 compares the restriction to the configuration of the UAV 102 associated with the mission objective(s) (block 520). In some examples, such a comparison enables the restriction/configuration comparator 212 and/or the compliance controller 218 to determine if the configuration of the UAV 102 is capable of being compliant with the restriction (block 522). For example, if the restriction data 134 places limitations on camera usage and the UAV 102 is capable of dynamically enabling/disabling the camera, the restriction/configuration comparator 212 and/or the compliance controller 218 determines that the UAV 102 is capable of complying with the restriction regardless of the current state of the camera (e.g., enabled/disabled). If the UAV 102 is capable of complying with the restriction, control advances to block 406. However, if the UAV 102 is not capable of complying with the restriction, control advances to block 512.

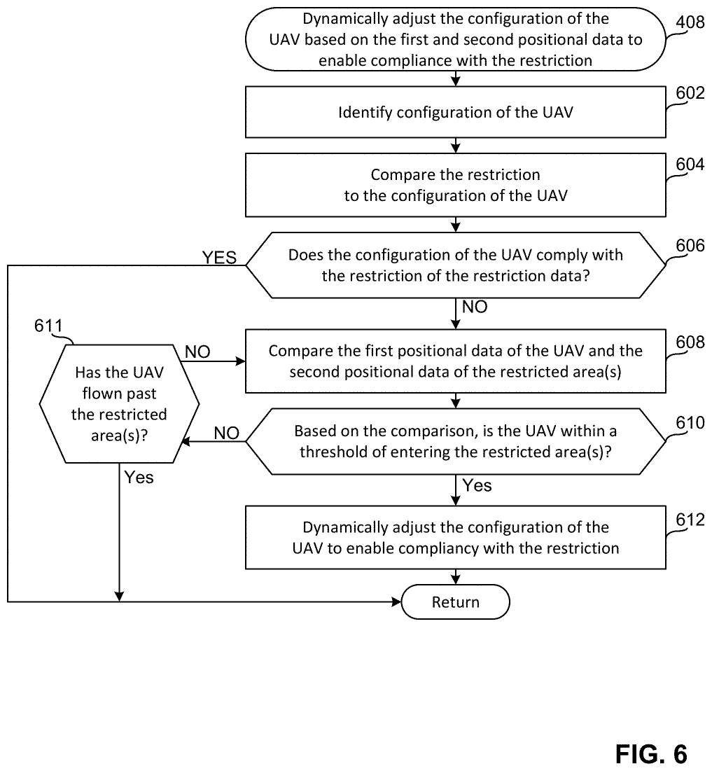

FIG. 6 illustrates an example of performing the processes of block 408 to dynamically adjust the configuration of the UAV 102 based on the first and second positional data to enable compliancy with the restriction. The program of FIG. 6 begins with the configuration identifier 210 identifying the configuration of the UAV 102 (block 602) and the restriction/configuration comparator 212 comparing the configuration of the UAV 102 to the restriction (block 604). In some examples, such a comparison enables the restriction/configuration comparator 212 and/or the compliance controller 218 to determine if the configuration of the UAV 102 is compliant with the restriction (block 606). If the restriction/configuration comparator 212 and/or the compliance controller 218 determines that the configuration of the UAV 102 complies with the restriction, control advances to block 410.

However, if the restriction/configuration comparator 212 and/or the compliance controller 218 determines that the configuration of the UAV 102 is not compliant with the restriction, control advances to block 608. For example, if the restriction limits the number of motors and/or propellers being operated to three and the configuration identifier 210 determines that the UAV 102 is operating six motors and/or propellers prior to entering the first restricted area 106, the restriction/configuration comparator 212 will determine that the UAV 102 does not comply with the three-motor limit based on the current operating mode.

To ensure that the UAV 102 complies with the restriction placed on the restricted area 106, 110, 114, the location comparator 216 compares the location of the UAV 102 to the location and/or boundary of the restricted area 106, 110, 114 (block 608). At block 610, the location comparator 212 determines when the UAV 102 is within a threshold of entering the restricted area 106, 110, 114 (block 610). If the UAV 102 is not within a threshold of entering the restricted area 106, 110, 114, the negotiator 206 determines whether or not the UAV 102 has flown past the restricted area 106, 110, 114 (block 611). For example, if the second positional data of the restricted area 106, 110, 114 is no longer in front of the first positional data of the UAV 102, the negotiator 206 determines that the UAV 102 has flown past the restricted area 106, 110, 114 and control advances to block 410.

If the UAV 102 is within a threshold of entering the restricted area 106, 110, 114, the compliance controller 218 communicates and/or otherwise provides the configuration command 142 to the UAV 102 to dynamically adjust the configuration of the UAV 102 to enable compliancy with the restriction (block 612).

The program of FIG. 7 begins with the boundary determiner 306 accessing boundary data from the database 308 to identify the boundary of the restricted area 106, 110, 114 (block 702). The boundary determiner 306 determines whether or not an update has been provided to add, update and/or remove the boundary (block 704). If a boundary update is available, the boundary determiner 306 accesses the boundary update from the terrestrial interface 302 and stores the boundary update in the database 308 (block 706).

To identify a restriction(s) imposed on the restricted area 106, 110, 114, the restriction determiner 304 accesses the restriction data 134 from the database 308 and identifies a restriction(s) associated with the restricted area 106, 110, 114 (block 708). The restriction determiner 304 determiners whether or not an update has been provided to add, update and/or remove a restriction (block 710). If a restriction update is available, the restriction determiner 304 accesses the restriction from the terrestrial interface 302 and stores the restriction update in the database 308 (block 712). At block 714, the UAV interface 310 interfaces with the UAV 102 to negotiate access through the restricted area 106, 110, 114 by the UAV 102 (block 714).

FIG. 8 is a block diagram of an example processor platform 800 capable of executing the instructions of FIGS. 4, 5 and 6 to implement the route planner 118 of FIGS. 1 and 2. The processor platform 800 can be, for example, a server, a personal computer, a mobile device (e.g., a cell phone, a smart phone, a tablet such as an iPad™), a personal digital assistant (PDA), an Internet appliance, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer. In this example, processor 812 implements the example mission objective determiner 202, the example flight path determiner 204, the example negotiator 206, the example restricted area identifier 208, the example configuration identifier 210, the example restriction/configuration comparator 212, the example location determiner 214, the example location comparator 216, the example compliance controller 218 and the example notice generator 220.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIGS. 4, 5 and 6 may be stored in the mass storage device 828, in the volatile memory 814, in the non-volatile memory 816, and/or on a removable tangible computer readable storage medium such as a CD or DVD.

FIG. 9 is a block diagram of an example processor platform 900 capable of executing the instructions of FIG. 7 to implement the area controller 108, 112, 116 of FIGS. 1 and 3. The processor platform 900 can be, for example, a server, a personal computer, a mobile device (e.g., a cell phone, a smart phone, a tablet such as an iPad™), a personal digital assistant (PDA), an Internet appliance, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer. In this example, the processor 912 implements the terrestrial interface 302, the restriction determiner 304, the boundary determiner 306 and the UAV interface 310.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIG. 7 may be stored in the mass storage device 928, in the volatile memory 914, in the non-volatile memory 916, and/or on a removable tangible computer readable storage medium such as a CD or DVD.

From the foregoing, it will be appreciated that the above disclosed methods, apparatus and articles of manufacture relate to negotiating access for aircraft through areas that may include restrictions on when actives may be performed and/or what activities may be performed when flying through the area. In some examples, the negotiation takes place prior to take off and/or during the flight. The examples disclosed herein also enable aircraft and/or associated systems to negotiate access through an area by agreeing to pay a fee. While the examples disclosed herein mention aircraft and/or unmanned aerial vehicles, the examples disclosed herein may additionally and/or alternatively be implemented on land-based vehicles and/or water-based vehicles.

To enable the aircraft to achieve a goal of a mission (e.g., arriving at a destination a particular time) and comply with a restriction, the configuration of the aircraft may be dynamically changed during flight. For example, if the mission goal is for the aircraft to fly 50 miles per hour (50 mph) and there is a speed limit of 45 mph in an area, the aircraft can dynamically adjust its speed to 45 mph when flying through the area. The examples disclosed herein enable people and/or entities affiliated with the area to update, change, removed and/or add restrictions and/or update, change, remove and/or add boundaries to an area. In other words, a first restriction may be updated or the first restriction may be removed all together.

### Example 1

An example apparatus includes an unmanned vehicle including a body and a propulsion source to propel the unmanned vehicle during flight; and a route planner to determine a route through an area including a restriction, the route planner to negotiate access through the restricted area.

### Example 2

In Example 1 or other examples, the route planner includes a negotiator to compare a mission objective of the unmanned vehicle to the restriction to determine compliance of the unmanned vehicle with the restriction, the unmanned vehicle to be granted access through the restricted area based on the unmanned vehicle complying with the restriction.

### Example 3

In Example 2 or other examples, in response to identifying the presence of the restricted area along the route, the negotiator to access restriction data associated with the restricted area to determine the presence of the restriction.

### Example 4

In Example 3 or other examples, the negotiator is to access the restriction data prior to flight.

### Example 5

In Examples 1 or 2 or other examples, the restriction includes a configuration restriction, the route planner includes a compliance controller to enable the unmanned vehicle to comply with the configuration restriction when the unmanned vehicle travels through the restricted area.

### Example 6

In Example 5 or other examples, the route planner includes a configuration identifier and a restriction/configuration comparator, the configuration identifier to determine a configuration of the unmanned vehicle and the restriction/configuration comparator to compare the configuration of the unmanned vehicle to the configuration restriction to determine if the unmanned vehicle complies with the configuration restriction.

### Example 7

In Example 6 or other examples, in response to the unmanned vehicle not complying with the configuration restriction, the compliance controller to dynamically change the configuration of the unmanned vehicle to enable the unmanned vehicle to comply with the configuration restriction when the unmanned vehicle travels through the restricted area.

### Example 8

In Example 6 or other examples, the route planner includes a location determiner and a location comparator, the location determiner to determine first positional data of the unmanned vehicle and the location comparator to compare the first positional data to second positional data of the restricted area to determine when the first positional data is within a threshold of the second positional data.

### Example 9

In Example 9 or other examples, in response to the unmanned vehicle not complying with the configuration restriction and the first positional data being within the threshold of the second positional data, the compliance controller to change the configuration of the unmanned vehicle to enable the unmanned vehicle to comply with the configuration restriction when the unmanned vehicle travels through the restricted area.

### Example 10

In Examples 1 or 2 or other examples, the route planner includes a notice generator to generate a notice associated with the unmanned vehicle complying with the restriction.

### Example 11

In Example 1 or other examples, the route planner includes a negotiator to compare a mission objective of the unmanned vehicle to the restriction, in response to the mission objective not complying with the restriction and the restriction including an access fee associated therewith, the negotiation including the negotiator determining to pay the access fee.

### Example 12

In Example 11 or other examples, in response to the negotiator determining to pay the access fee, the unmanned vehicle to access the restricted area.

### Example 13

In Examples 1 or 2 or other examples, the route includes a first route and the route planner includes a flight path determiner, in response to a mission objective not complying with the restriction, the flight path determiner to determine a second route that avoids traveling through the restricted area.

### Example 14

In Examples 1 or 2 or other examples, the unmanned vehicle includes the route planner.

### Example 15

In Examples 1 or 2 or other examples, the unmanned vehicle includes an unmanned aerial vehicle.

### Example 16

An example method includes determining, by executing an instruction with at least one processor, a route for an unmanned vehicle through an area including a restriction; and negotiating, by executing an instruction with at least one processor, access through the restricted area.

### Example 17

In Example 16 or other examples, the negotiating includes comparing a mission objective of the unmanned vehicle to the restriction to determine compliance of the unmanned vehicle with the restriction, the unmanned vehicle being granted access through the restricted area based on the unmanned vehicle complying with the restriction.

### Example 18

In Example 17 or other examples, in response to identifying the presence of the restricted area along the route, accessing restriction data associated with the restricted area to determine the presence of the restriction.

### Example 19

In Example 17 or other examples, accessing the restriction data including accessing the restriction data prior to flight.

### Example 20

In Examples 16 or 17 or other examples, the restriction includes a configuration restriction, further including enabling the unmanned vehicle to comply with the configuration restriction when the unmanned vehicle travels through the restricted area.

### Example 21

In Example 20 or other examples, further including determining a configuration of the unmanned vehicle and comparing the configuration of the unmanned vehicle to the configuration restriction to determine if the unmanned vehicle complies with the configuration restriction.

### Example 22

In Example 21 or other examples, in response to the unmanned vehicle not complying with the configuration restriction, changing the configuration of the unmanned vehicle to enable the unmanned vehicle to comply with the configuration restriction when the unmanned vehicle travels through the restricted area.

### Example 23

In Example 21 or other examples, further including determining first positional data of the unmanned vehicle and comparing the first positional data to second positional data of the restricted area to determine when the first positional data is within a threshold of the second positional data.

### Example 24

In Example 23 or other examples, in response to the unmanned vehicle not complying with the configuration restriction and the first positional data being within the threshold of the second positional data, changing the configuration of the unmanned vehicle to enable the unmanned vehicle to comply with the configuration restriction when the unmanned vehicle travels through the restricted area.

### Example 25

In Examples 16 or 17 or other examples, further including generating a notice associated with the unmanned vehicle complying with the restriction.

### Example 26

In Examples 16 or 17 or other examples, further including comparing a mission objective of the unmanned vehicle to the restriction, in response to the mission objective not complying with the restriction and the restriction including an access fee associated therewith, determining to pay the access fee.

### Examples 27

In Example 26 or other examples, in response to determining to pay the access fee, accessing the restricted area with the unmanned vehicle.

### Example 28

In Example 16 or other examples, further including, in response to a mission objective not complying with the restriction, determining a second route that avoids traveling through the restricted area.

### Example 29

An example tangible computer-readable medium comprising instructions that, when executed, cause a processor to, at least: determine a route for an unmanned vehicle through an area including a restriction; and negotiate access through the restricted area.

### Example 30

In Example 29 or other examples, the negotiating includes comparing a mission objective of the unmanned vehicle to the restriction to determine compliance of the unmanned vehicle with the restriction, the unmanned vehicle being granted access through the restricted area based on the unmanned vehicle complying with the restriction.

### Example 31

In Example 30 or other examples, the instructions, when executed, further cause the processor to access restriction data associated with the restricted area to determine the presence of the restriction in response to identifying the presence of the restricted area along the route.

### Example 32

In Example 30 or other examples, accessing the restriction data includes accessing the restriction data prior to flight.

### Example 33

In Examples 29 or 30 or other examples, the restriction includes a configuration restriction, wherein the instructions, when executed, further cause the processor to enable the unmanned vehicle to comply with the configuration restriction when the unmanned vehicle travels through the restricted area.

### Example 34

In Example 33 or other examples, the instructions, when executed, further cause the processor to determine a configuration of the unmanned vehicle and compare the configuration of the unmanned vehicle to the configuration restriction to determine if the unmanned vehicle complies with the configuration restriction.

### Example 35

In Example 34 or other examples the instructions, when executed, further cause the processor to change the configuration of the unmanned vehicle to enable the unmanned vehicle to comply with the configuration restriction when the unmanned vehicle travels through the restricted area in response to the unmanned vehicle not complying with the configuration restriction.

### Example 36

In Example 34 or other examples, the instructions, when executed, further cause the processor to determine first positional data of the unmanned vehicle and compare the first positional data to second positional data of the restricted area to determine when the first positional data is within a threshold of the second positional data.

### Example 37

In Example 36 or other examples, the instructions, when executed, further cause the processor to change the configuration of the unmanned vehicle to enable the unmanned vehicle to comply with the configuration restriction when the unmanned vehicle travels through the restricted area in response to the unmanned vehicle not complying with the configuration restriction and the first positional data being within the threshold of the second positional data.

### Example 38

In Examples 29 or 30 or other examples, the instructions, when executed, further cause the processor to generate a notice associated with the unmanned vehicle complying with the restriction.

### Example 39

In Examples 29 or 30 or other examples, the instructions, when executed, further cause the processor to compare a mission objective of the unmanned vehicle to the restriction in response to the mission objective not complying with the restriction and the restriction including an access fee associated therewith, determine to pay the access fee.

### Example 40

In Example 39 or other examples, the instructions, when executed, further cause the processor to access the restricted area with the unmanned vehicle in response to determining to pay the access fee.

### Example 41

In Example 29 or other examples, the instructions, when executed, further cause the processor to determine a second route that avoids traveling through the restricted area in response to a mission objective not complying with the restriction.

### Example 42

An example system for use with an unmanned vehicle includes means for determining a route for an unmanned vehicle through an area including a restriction; and means for negotiating access through the restricted area.

### Example 43

In Example 42 or other examples, the negotiating includes comparing a mission objective of the unmanned vehicle to the restriction to determine compliance of the unmanned vehicle with the restriction, the unmanned vehicle being granted access through the restricted area based on the unmanned vehicle complying with the restriction.

### Example 44

In Example 43 or other examples, further including means for accessing restriction data associated with the restricted area to determine the presence of the restriction in response to identifying the presence of the restricted area along the route.

### Example 45

In Example 43 or other examples, accessing the restriction data including accessing the restriction data prior to flight.

### Example 46

In Examples 42 or 43 or other examples, the restriction includes a configuration restriction, further including means for enabling the unmanned vehicle to comply with the configuration restriction when the unmanned vehicle travels through the restricted area.

### Example 47

In Example 46 or other examples, further including means for determining a configuration of the unmanned vehicle and comparing the configuration of the unmanned vehicle to the configuration restriction to determine if the unmanned vehicle complies with the configuration restriction.

### Example 48

In Example 47 or other examples, further including means for changing the configuration of the unmanned vehicle to enable the unmanned vehicle to comply with the configuration restriction when the unmanned vehicle travels through the restricted area in response to the unmanned vehicle not complying with the configuration restriction.

### Example 49

In Example 47 or other examples, further including means for determining first positional data of the unmanned vehicle and comparing the first positional data to second positional data of the restricted area to determine when the first positional data is within a threshold of the second positional data.

### Example 50

In Example 49 or other examples, further including means for changing the configuration of the unmanned vehicle to enable the unmanned vehicle to comply with the configuration restriction when the unmanned vehicle travels through the restricted area in response to the unmanned vehicle not complying with the configuration restriction and the first positional data being within the threshold of the second positional data.

### Example 51

In Examples 42 or 43 or other examples, further including means for generating a notice associated with the unmanned vehicle complying with the restriction.

### Example 52

In Examples 42 or 43 or other examples, further including means for comparing a mission objective of the unmanned vehicle to the restriction in response to the mission objective not complying with the restriction and the restriction including an access fee associated therewith, means for determining to pay the access fee.

### Example 53

In example 52 or other examples, further including means for accessing the restricted area with the unmanned vehicle in response to the means for determining to pay the access fee.

### Example 54

In Examples 42 or 43 or other examples, further including means for determining a second route that avoids traveling through the restricted area in response to a mission objective not complying with the restriction.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1-25. (canceled)

26. An unmanned vehicle comprising:
a body;
a propulsion source to propel the unmanned vehicle during flight; and
a route planner tool to:
compare a restriction in a restricted area with a configuration of the unmanned vehicle to determine whether the configuration of the unmanned vehicle is compliant with the restriction; and
in response to the configuration of the unmanned vehicle being compliant with the restriction, determine a route for the unmanned vehicle to travel through the restricted area.

27. The unmanned vehicle of claim 26, wherein the route planner tool is to compare a mission objective of the unmanned vehicle to the restriction to determine compliance of the unmanned vehicle with the restriction, the unmanned vehicle to be granted access through the restricted area based on the mission objective complying with the restriction.

28. The unmanned vehicle of claim 27, wherein in response to identifying the restriction along the route, the route planner tool is to access restriction data associated with the restriction.

29. The unmanned vehicle of claim 28, wherein the route planner tool is to access the restriction data prior to flight.

30. The unmanned vehicle of claim 26, wherein the route planner tool includes a configuration identifier to determine a configuration of the unmanned vehicle, the configuration including at least one of a presence of a camera on the unmanned vehicle, a number of motors on the unmanned vehicle, a number of propellers on the unmanned vehicle, a data transmission capability, a data storage capability, a video storage capability, or a maximum speed of the unmanned vehicle.

31. The unmanned vehicle of claim 26, wherein in response to the unmanned vehicle not complying with the restriction, the route planner tool is to command the unmanned vehicle to change the configuration of the unmanned vehicle to enable the unmanned vehicle to comply with the restriction when the unmanned vehicle travels through the restricted area.

32. The unmanned vehicle of claim 26, wherein the route planner tool includes a location determiner and a location comparator, the location determiner to determine first positional data of the unmanned vehicle and the location comparator to compare the first positional data to second positional data of the restricted area to determine when the first positional data is within a threshold of the second positional data.

33. The unmanned vehicle of claim 32, wherein in response to the unmanned vehicle not complying with the restriction and the first positional data being within the threshold of the second positional data, the route planner tool is to change the configuration of the unmanned vehicle to enable the unmanned vehicle to comply with the restriction when the unmanned vehicle travels through the restricted area.

34. The unmanned vehicle of claim 26, wherein the route planner tool includes a notice generator to generate a notice associated with the unmanned vehicle complying with the restriction.

35. The unmanned vehicle of claim 26, wherein, in response to the configuration of the unmanned vehicle not complying with the restriction and the restriction including an access fee associated therewith, the route planner tool is to initiate payment of the access fee.

36. The unmanned vehicle of claim 35, wherein in response to the route planner tool initiating the payment of the access fee, the unmanned vehicle is to access the restricted area.

37. The unmanned vehicle of claim 26, wherein the route includes a first route and the route planner tool includes a flight path determiner to, in response to a mission objective of the unmanned vehicle not complying with the restriction, determine a second route that avoids traveling through the restricted area.

38. A method, comprising:
comparing, by executing an instruction with at least one processor, a restriction in a restricted area with a configuration of an unmanned vehicle to determine whether the configuration of the unmanned vehicle is compliant with the restriction; and
in response to the configuration of the unmanned vehicle being compliant with the restriction, determining, by executing an instruction with the at least one processor, a route for the unmanned vehicle to travel through the restricted area.

39. The method of claim 38, further including comparing a mission objective of the unmanned vehicle to the restriction to determine compliance of the unmanned vehicle with the restriction, the unmanned vehicle granted access through the restricted area in response to the unmanned vehicle complying with the restriction.

40. The method of claim 38, further including determining a configuration of the unmanned vehicle, the configuration including at least one of a presence of a camera on the unmanned vehicle, a number of motors on the unmanned vehicle, a number of propellers on the unmanned vehicle, a data transmission capability, a data storage capability, a video storage capability, or a maximum speed of the unmanned vehicle.

41. The method of claim 38, further including, in response to the unmanned vehicle not complying with the restriction, changing the configuration of the unmanned vehicle to enable the unmanned vehicle to comply with the restriction when the unmanned vehicle travels through the restricted area.

42. A tangible computer-readable medium comprising instructions that, when executed, cause at least one processor to, at least:
compare a restriction in a restricted area with a configuration of an unmanned vehicle to determine whether the configuration of the unmanned vehicle is compliant with the restriction; and
in response to the configuration of the unmanned vehicle being compliant with the restriction, determine a route for the unmanned vehicle to travel through the restricted area.

43. The computer-readable medium as defined in claim 42, wherein the instructions, when executed, cause the at least one processor to determine a configuration of the unmanned vehicle, the configuration including at least one of a presence of a camera on the unmanned vehicle, a number of motors on the unmanned vehicle, a number of propellers on the unmanned vehicle, a data transmission capability, a data storage capability, a video storage capability, or a maximum speed of the unmanned vehicle.

44. The computer-readable medium as defined in claim 43, wherein the instructions, when executed, cause the at least one processor to command the unmanned vehicle to change a setting associated with the configuration of the unmanned vehicle to enable the unmanned vehicle to comply with the restriction when the unmanned vehicle travels through the restricted area in response to the unmanned vehicle not complying with the restriction, the setting including at least one of whether the camera is enabled, whether one or more of the motors are enabled, whether one or more of the propellers are enabled, whether the data transmission capability is enabled, whether the data storage capability is enabled, whether the video storage capability is enabled, or a speed of the unmanned vehicle.

45. The computer-readable medium as defined in claim 44, wherein the instructions, when executed, cause the at least one processor to determine first positional data of the unmanned vehicle and compare the first positional data to second positional data of the restricted area to determine when the first positional data is within a threshold of the second positional data; and to change the configuration of the unmanned vehicle to enable the unmanned vehicle to comply with the restriction when the unmanned vehicle travels through the restricted area in response to the unmanned vehicle not complying with the restriction and the first positional data being within the threshold of the second positional data.
